(19) United States
(12) Patent Application Publication
(10) Pub. No.: US 2010/0044639 A1
(43) Pub. Date: Feb. 25, 2010

(54) STABILIZED CORE-SHELL NANOPARTICLES OF HYDROPHOBIC METAL COMPLEXES AND REPRECIPATION-ENCAPSULATION METHOD FOR PREPARING SAME

(76) Inventors: Jason D. McNeill, Clemson, SC (US); Changfeng Wu, Clemson, SC (US); Hongshang Peng, Beijing (CN)

Correspondence Address: Ballard Spahr LLP, SUITE 1000, 999 PEACHTREE STREET, ATLANTA, GA, 30309-3915, US

(21) Appl. No.: 12/255,436

(22) Filed: Oct. 21, 2008

Related U.S. Application Data
(60) Provisional application No. 60/982,008, filed on Oct. 23, 2007.

(51) Int. Cl. C09K 11/02; B32B 5/16

(52) U.S. Cl. 252/301.36; 428/402; 977/773

(57) ABSTRACT

In one aspect, the invention relates to stable, luminescent, lanthanide-based nanoparticles and methods for making same. Thus, disclosed are lanthanide-based nanoparticles exhibiting a luminescence brightness of at least about 4%×(3×10⁷ M⁻¹ cm⁻¹) with a particle diameter of less than about 100 nm; stable, luminescent nanoparticles with cores comprising at least one lanthanide chelate and a shell comprising organic silane residues; and processes for preparing a stable, luminescent nanoparticle, the process comprising the step of combining a basic protic solvent with a mixture of an alkylsilane and an aprotic solution of lanthanide chelate. This abstract is intended as a scanning tool for purposes of searching in the particular art and is not intended to be limiting of the present invention.

This application claims the benefit of and priority to U.S. Provisional Application No. 60/982,008, filed Oct. 23, 2007, which is hereby incorporated herein by reference in its entirety.

### ACKNOWLEDGMENT

This invention was made with government support under Grant Nos. 0547846, 2001 RII-EPS-0132573, and 2004 RII-EPS-0447660 awarded by the National Science Foundation. The United States government has certain rights in the invention.

### BACKGROUND

Trivalent lanthanide (Ln³⁺) chelates have a number of useful spectroscopic characteristics such as near-UV excitation, sharp emission peaks, highly red-shifted luminescence, and long luminescence lifetimes. These characteristics can provide very low detection limits and enhanced sensitivity in luminescence-based detection schemes. For biological applications such as in vivo sensing and imaging, the Ln³⁺ chelates are desirably soluble, stable, free of nonspecific interactions, and sufficiently bright in aqueous solution. However, with conventional techniques, the luminescence quantum yield of Ln³⁺ chelates is usually reduced substantially as a result of quenching by water molecules. In certain cases, they also suffer from nonspecific interactions with various cations (such as Ca²⁺ and Zn²⁺) and anions (e.g., hydroxide and phosphate). Therefore, much effort has been devoted to developing luminescent Ln³⁺ chelates with improved stability and quantum yield.

As an alternative, silica or polystyrene nanoparticles containing Ln³⁺ chelates have been prepared for biological assays. In comparison with free Ln³⁺ chelate molecules, the luminescence brightness of chelate nanoparticles is greatly enhanced, because there are many chelate molecules per particle. Furthermore, the Ln³⁺ chelates are stabilized by the nanoparticle matrix. However, a shortcoming of these nanoparticles is their large size (>40 nm), which limits their potential applications, particularly for FRET-based detection schemes such as molecular beacons. Inorganic nanoparticles containing Ln³⁺ ions have also been developed as potential bioprobes, though the small absorption cross section of Ln³⁺ ions, large particle size, and broad size range limit their utility for many applications.

Therefore, there remains a need for methods and compositions that overcome these deficiencies and that effectively provide stable, luminescent, lanthanide-based nanoparticles with improved stability and quantum yield and satisfactory particle size.

### SUMMARY

As embodied and broadly described herein, the invention, in one aspect, relates to stable, luminescent, lanthanide-based nanoparticles and methods for making same.

Disclosed are lanthanide-based nanoparticles exhibiting a luminescence brightness of at least about 4%×(3×10⁷ M⁻¹ cm⁻¹) with a particle diameter of less than about 100 nm.

Also disclosed are stable, luminescent nanoparticles comprising a core comprising at least one lanthanide chelate and a shell comprising organic silane residues, wherein the nanoparticle exhibits a molar extinction coefficient of at least about 3×10⁷ M⁻¹ cm⁻¹ at its wavelength of maximum absorbance from about 300 nm to about 400 nm and/or wherein the nanoparticle exhibits a luminescence quantum yield of at least about 4%, and wherein the nanoparticle exhibits a luminescence brightness of at least about 4%×(3×10⁷ M⁻¹ cm⁻¹).

Also disclosed are process for preparing a stable, luminescent nanoparticle, the process comprising the step of combining a basic protic solvent with a mixture of an alkylsilane and an aprotic solution of lanthanide chelate.

Also disclosed are products of the disclosed processes.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

The accompanying drawings, which are incorporated in and constitute a part of this specification, illustrate several embodiments and together with the description illustrate the disclosed compositions and methods.

FIG. 1 shows a UV-vis absorption and emission spectrum of Eu(DBM)₃TPPO in THF solution. (Inset) Chemical structure of the Eu(DBM)₃TPPO molecule.

FIG. 2 shows time-dependent UV-vis absorption spectra of a freshly prepared Eu(DBM)₃TPPO pure (without OTS) nanoparticle suspension. The absorption spectra are measured every 10 min, with the sequence indicated by the arrow. (Inset) Time-dependent intensity change of 613 nm emission from the pure Eu(DBM)₃TPPO nanoparticles. Emission intensity is normalized to the initial value.

FIG. 3 shows AFM images of Eu(DBM)₃TPPO nanoparticles prepared (a) without OTS and with Eu(DBM)₃TPPO/OTS nanoparticles with molar ratios of (b) 1:1, (c) 1:5, and (d) 1:10. The scale bar is 200 nm. (e) Histogram of particle height taken on an AFM image with sparsely dispersed nanoparticles (with a 1:5 Eu(DBM)₃TPPO/OTS ratio). (f) Time dependence of the 613 nm emission intensity of freshly prepared Eu(DBM)₃TPPO/OTS nanoparticles with varying molar ratios of OTS. Molar ratios of 1:1, 5:1, and 10:1 are respectively labeled as ▴, ▾, and ▪. The emission intensity is normalized to the initial value.

FIG. 4 shows (a) Emission spectra, (b) luminescence decay, and (c) 20 photobleaching curves of Eu(DBM)₃TPPO in THF solution and 5:1 Eu(DBM)₃TPPO/OTS nanoparticle dispersions. In all cases, the absorbance is adjusted to 0.1. Emission spectra and photobleaching curves were recorded under continuous illumination of 360 nm UV light.

### DETAILED DESCRIPTION

The present invention can be understood more readily by reference to the following detailed description of the invention and the Examples included therein.

Before the present compounds, compositions, articles, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular embodiments only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which may need to be independently confirmed.

### A. Definitions

As used in the specification and the appended claims, the singular forms “a,” “an” and “the” include plural referents unless the context clearly dictates otherwise. Thus, for example, reference to “a component,” “a polymer,” or “a residue” includes mixtures of two or more such components, polymers, or residues, and the like.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance may or may not occur, and that the description includes instances where said event or circumstance occurs and instances where it does not.

A residue of a chemical species, as used in the specification and concluding claims, refers to the moiety that is the resulting product of the chemical species in a particular reaction scheme or subsequent formulation or chemical product, regardless of whether the moiety is actually obtained from the chemical species. Thus, an ethylene glycol residue in a polyester refers to one or more —OCH₂CH₂O— units in the polyester, regardless of whether ethylene glycol was used to prepare the polyester. Similarly, a sebacic acid residue in a polyester refers to one or more —CO(CH₂)₈CO— moieties in the polyester, regardless of whether the residue is obtained by reacting sebacic acid or an ester thereof to obtain the polyester.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B—F, C-D, C-E, and C—F are considered disclosed. Likewise, any subset or combination of these is also disclosed. Thus, for example, the sub-group of A-E, B—F, and C-E would be considered disclosed. This concept applies to all aspects of this application including, but not limited to, steps in 30 methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. Nanoparticles Prepared by Reprecipitation—Encapsulation

Various organic nanoparticles based on fluorescent dyes [Xiao, D. B.; Lu, X.; Yang, W. S.; Fu, H. B.; Shttai, Z. G.; Fang, Y.; Yao, J. N. J. Am. Chem. Soc. 2003, 125, 6740-6745.; Peng, A. D.; Xiao, D. B.; Ma, Y.; Yang, W. S.; Yao, J. N. Ado. Mater. 2005, 17, 2070-2073.] and conjugated polymers [Szymanski, C.; Wu, C. F.; Hooper, J.; Salazar, M. A.; Perdomo, A.; Dukes, A.; McNeill, J. J. Phys. Chem. B 2005, 109, 8543-8546.; Wu, C.; Szymanski, C.; McNeill, J. Langmuir 2006, 22, 2956-2960.; Wu, C.; Peng, H.; Jiang, Y.; McNeill, J. J. Phys. Chem. B 2006, 110, 14148-14154.] have been prepared by reprecipitation methods. Recently, Mirkin et al. demonstrated the preparation of colloidal particles of polymeric transition metal chelates with particle sizes ranging from submicrometer to micrometer. [Oh, M.; Mirkin, C. A. Nature 2005, 438, 651-654.]

In contrast, it has been found that smaller Eu³⁺ chelate nanoparticles can be prepared by a reprecipitation-encapsulation method. In the absence of an encapsulation agent, Eu³⁺ chelate particles prepared by reprecipitation are observed to aggregate over the period of a few hours and also exhibit a notable reduction in luminescence.

Thus, it has been demonstrated that the addition of an encapsulating agent (e.g., an electrophilic alkylsilane such as octyltrimethoxysilane; OTS) results in stable nanoparticle dispersions that exhibit strong luminescence with a quantum yield even higher than that of the Eu³⁺ chelate dissolved in an organic solvent. The resulting nanoparticles have, for example, an average size of 10 nm, from which it can be determined that each particle contains approximately 1000 Eu³⁻ chelate molecules. On the basis of the stability, high luminescence brightness, and small size of these nanoparticles, these are suitable candidates for demanding applications such as luminescent labels or ultrasensitive assays.

### C. Lanthanide-Based Nanoparticle Luminescence

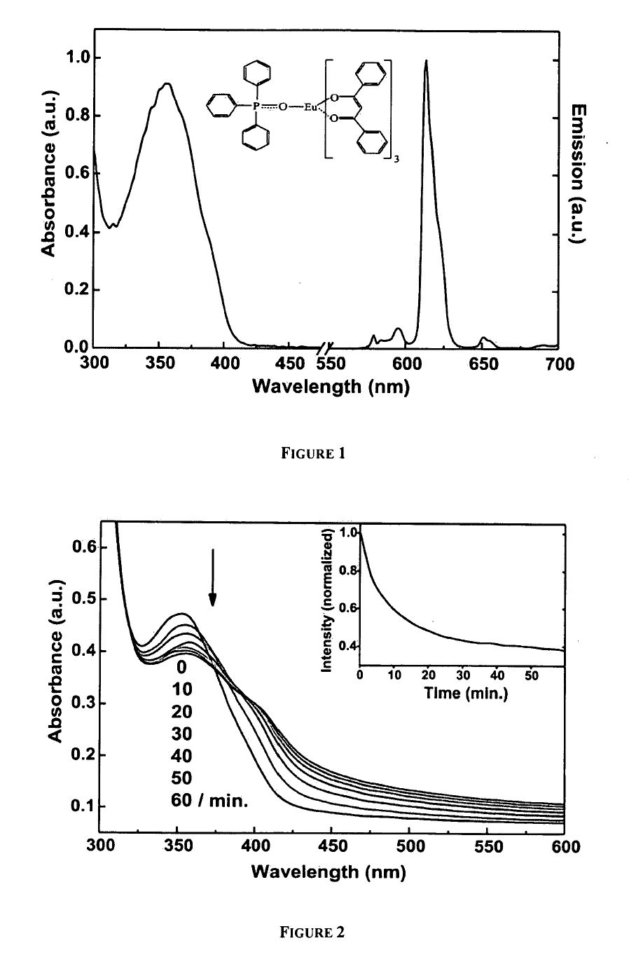

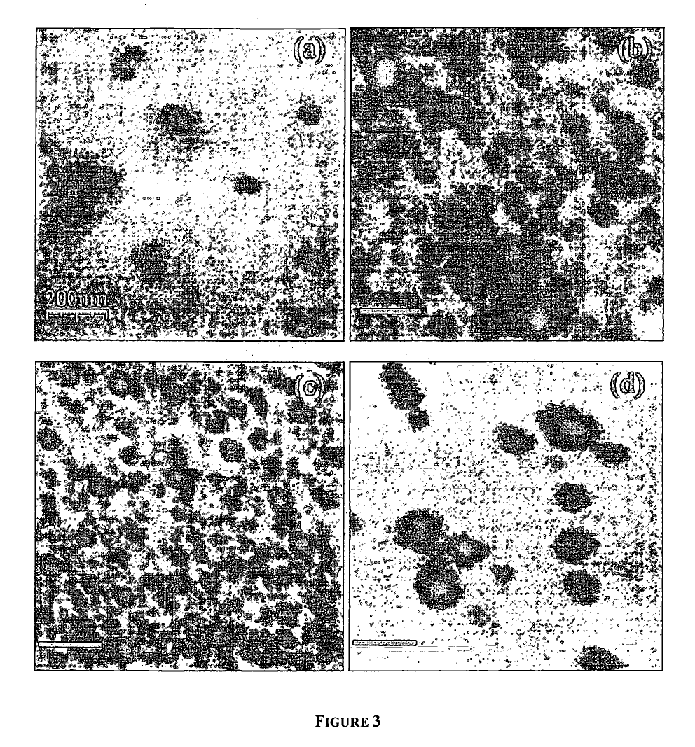

The luminescence of lanthanide ions arises from parity-forbidden 4f-4f transitions that typically exhibit very low extinction coefficients (1-10 M⁻¹/cm⁻¹). [Selvin, P. R. Annu. Rev. Biophys. Bioniol. Struct. 2002, 31, 275-302.] The extinction coefficients can be effectively increased by the well-known “antenna effect,” whereby organic chromophores coordinated with lanthanide ions serve as antennas to absorb light and then transfer energy to the metal ions. β-Diketone ligands such as dibenzoylmethane are often used in lanthanide complexes because of their stable coordination with Eu³⁻ ions and strong absorption in the near-UV region. [Zhao, D.; Qin, W. P.; Zhang, J. S.; Wu, C. F.; Qin, G. S.; De, G. J. H.; Zhang, J. S.; Lu, S. Z. Chem. Phys. Lett. 2005. 403, 129-134.; Zhao, D.; Qin, W. P.; Wu, C. F.; Qin, G. S.; Zhang, J. S.; Lu, S. Z. Chem. Phys. Lett. 2004, 388, 400-405.] FIG. 1 presents the chemical structure of Eu(DBM)₃TPPO and the absorption and emission spectra of this chelate in THF solution. The 355 nm absorption band is attributed to the absorption of dibenzoylmethane. The luminescence of the compound is dominated by the forced electric dipole transitions of Eu³⁺ ions (613 nm, ⁵D₀-⁷F₂), which are sensitive to the ligand field and site symmetry occupied by the Eu³⁺ ion.

A facile reprecipitation method for preparing hydrophobic conjugated polymer nanoparticles was recently demonstrated [Szymanski, C.; Wu, C. F.; Hooper, J.; Salazar, M. A.; Perdomo, A.; Dukes, A.; McNeill, J. J. Phys. Chem. B 2005, 109, 8543-8546.; Wu, C.; Szymanski, C.; McNeill, J. Langmuir 2006, 22, 2956-2960.; Wu, C.; Peng, H.; Jiang, Y.; McNeill, J. J. Phys. Chem. B 2006, 110, 14148-14154.]. This method can be also applied to hydrophobic Ln³⁺ chelate molecules. After injection of pure Eu(DBM)₃TPPO/THF solution, the resulting suspension is slightly hazy, exhibiting the characteristic Tyndall effect of colloidal systems. However, it is observed that the suspension slowly becomes faint blue and then white, indicating aggregation to form large particles. To monitor the evolution of the Eu³⁺ chelate particle suspension, the evolution of the absorption and luminescence spectra over time was recorded immediately after injection, as shown in FIG. 2 and its inset. A bathochromic shift of the 355 nm absorption band is observed as well as the emergence of a lower-energy trailing edge, which is attributable to the presence of aggregates. FIG. 2 (inset) indicates the intensity change of 613 nm emission from the freshly prepared bare nanoparticles under continuous UV excitation over the course of 1 h. The luminescence of these bare particles decreases very quickly. Without wishing to be bound by theory, it is believed that the rapid decrease is likely due to one or more of the following mechanisms: dissociation of the Eu³⁺ chelate molecules on the exposed cluster surfaces, efficient nonradiative relaxation via coupling to O—H vibrations of water, [Sammes, P. G.; Yahioglu, G. Nat. Prod Rep. 1996, 13, 1-28.] and rapid photodestruction.

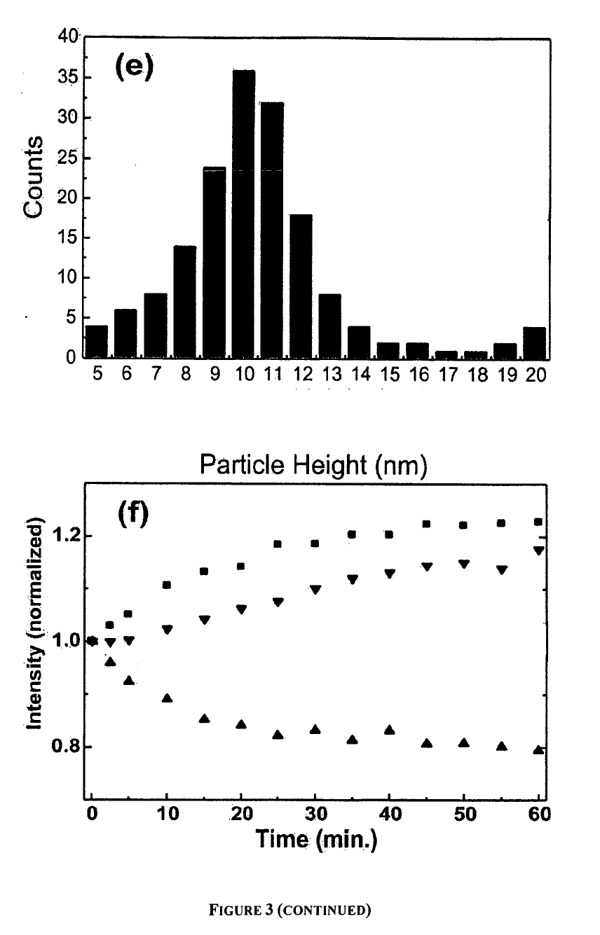

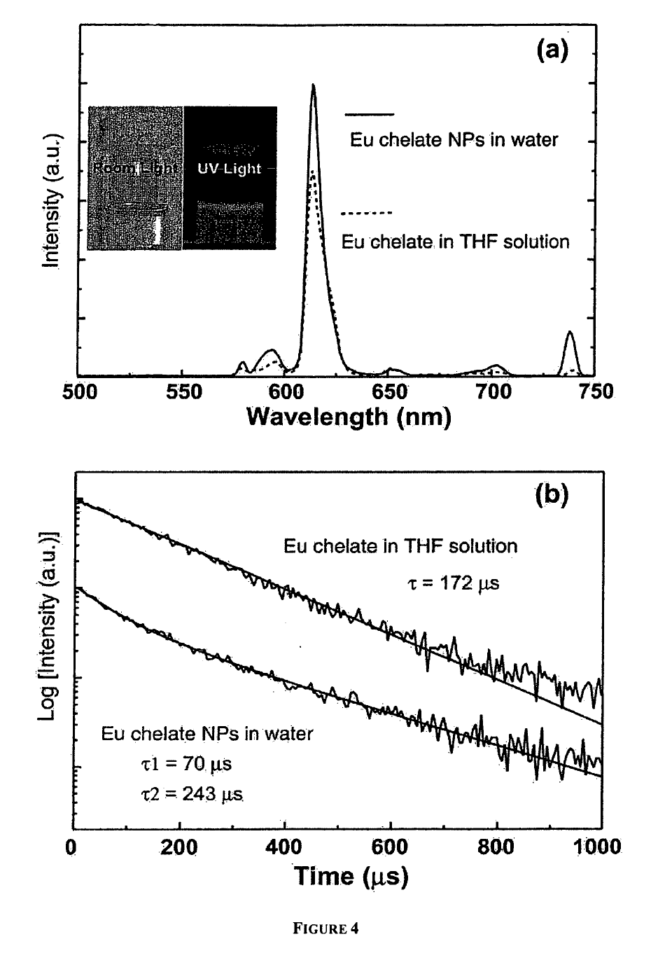

Encapsulated Eu(DBM)₃TPPO nanoparticles prepared in the presence of OTS exhibit markedly different behavior. The nanoparticle suspensions exhibit stable luminescence and remain transparent for weeks with no apparent aggregation. Tapping mode AFM was used to determine the dependence of nanoparticle morphology on the molar ratio of OTS to Eu(DBM)₃TPPO (FIG. 3). For suspensions prepared without the OTS, the presence of very small particles (likely containing a few molecules) as well as larger aggregates can both be seen in the AFM image (FIG. 3a). With the addition of a small amount of OTS (1:1 OTS/Eu(DBM)₃TPPO molar ratio), the AFM image indicates a somewhat narrower range of particle sizes (FIG. 3b). With an increase in the OTS/Eu(DBM)₃TPPO molar ratio to 5:1, the resulting nanoparticles exhibit a narrower size distribution, with few aggregates visible in the image (FIG. 3c). A further increase in the molar ratio to 10:1 leads to larger particles and a large size distribution (FIG. 3d). Without wishing to be bound by theory, it is believed that 5:1 is the optimal ratio for the formation of a stable, relatively monodisperse nanoparticle suspension. Height analysis (FIG. 3e) performed on an AFM image with sparse particle coverage indicates that the majority of these nanoparticles have diameter in the range of 5-15 nm. The larger lateral particle size in FIG. 3c relative to the particle height can be attributed to the tip convolution effect. [Morris, V. J.; Kirby, A. R.; Gunning, A. P. Atomic Force Microscopy for Biologists; Imperial College Press: London, 1999.] Evidence of nanoparticle nucleation and growth and the formation of the encapsulating alkoxysilane shell be observed in the time evolution of the absorption and luminescence spectra of the freshly prepared Eu(DBM)₃TPPO suspensions. The absorption spectra of the encapsulated nanoparticles remain unchanged for weeks, consistent with the relatively low occurrence of aggregates observed in the AFM results. However, there are remarkable differences in the luminescence intensity that depend on the OTS/chelate ratio, as shown in FIG. 3f. The luminescence intensity of the sample prepared with a 1:1 OTS/chelate ratio is observed to decrease gradually with time. However, for the nanoparticles prepared with higher ratios of OTS (5:1 and 10:1), the luminescence (at 613 nm) is observed to increase over time. These results are consistent with improved isolation of the Eu³⁺ ions from water with higher ratios of OTS to chelate.

Without wishing to be bound by theory, it is believed that the gradual increase in intensity can be explained by the adsorption and hydrolysis of the alkoxysilane molecules on the surface of the hydrophobic chelate particles resulting in the formation of a protecting layer, effectively isolating the Eu³⁺ ions from water and thus reducing the deleterious effects of water on the luminescence yield. It is also possible that some water is present, initially trapped in the nanoparticles upon formation that slowly exits the interior of the nanoparticles by diffusion, possibly accompanied by reorganization and densification of the particles. To test the importance of base-catalyzed hydrolysis of the OTS on nano-particle stability, the time evolution of spectra from Eu³⁺ chelate/OTS nanoparticles prepared without ammonia was measured. The temporal evolution of both the absorption spectra and the 613 nm emission of the resulting suspension is similar to that of suspensions formed without OTS. This indicates that the rapid hydrolysis of the OTS in a basic environment plays a role in inhibiting aggregation, for example as a result of interparticle electrostatic repulsion due to the negatively charged silica layer. In certain aspects, sonication during the mixing step is required for the formation of the nanoparticle suspension. This indicates that rapid mixing due to the formation of microjets in the mixture under sonication can ensure uniform nucleation and growth of the chelate nanoparticles.

Whereas some batch-to-batch variability in optical properties and particle diameters was observed, it can be concluded that a stable, relatively monodisperse Eu(DBM)₃TPPO nanoparticle suspension is obtained in the presence of OTS (with an OTS/Eu(DBM)₃TPPO molar ratio of 5:1 or weight ratio of 1:1.

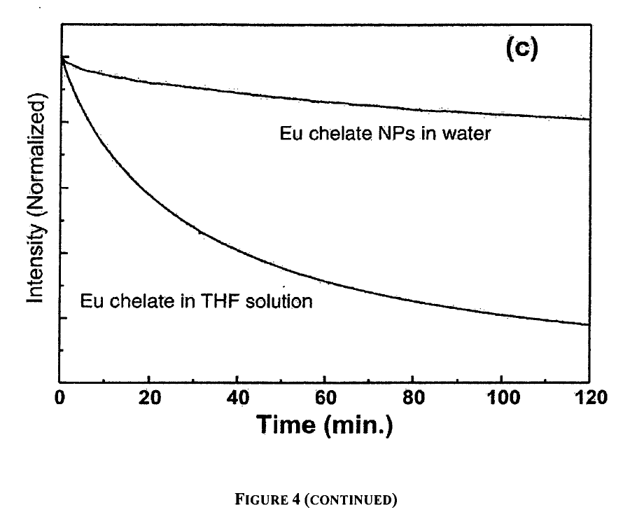

As shown in the inset of FIG. 4a, the nanoparticle dispersions are clear and colorless but exhibit strong red luminescence for weeks. To evaluate the long-term stability of the Eu³⁺ chelate/OTS nanoparticles toward aggregation, samples filtered through a 0.2 μm filter after aging for 4 weeks indicated no loss of material, as determined by UV-vis absorption spectroscopy. The molar extinction coefficient of the Eu(DBM)₃TPPO molecules in THF solution was determined to be 5.0×10⁴ M⁻¹cm⁻¹ at 350 nm. With nanoparticles having an average size of 10 nm, it can be determined that each particle contains about 1000 Eu³⁺ chelate molecules, yielding a nanoparticle molar extinction coefficient of about 5×10^{7 M}⁻¹ cm⁻¹ at 350 nm, which is much higher than that of conventional fluorescent dyes and semiconducting quantum dots. [Leatherdale, C. A.; Woo, W. K.; Mikulec, F. V.; Bawendi, M. G. J Phys. Chem. B 2002, 106, 7619-7622.] It should be noted that a unique feature of the nanoparticles is that such a large number of Ln³⁺ chelate molecules are contained in such a small particle. The photoluminescence quantum yield of the Ln³⁺ chelate molecules is not observed to decrease in the nanoparticles relative to dilute solution, despite the high concentration of Ln³⁺ chelate molecules within the particles, in contrast to many conventional organic fluorescent dyes that exhibit self-quenching at high concentrations. Without wishing to be bound by theory, it is believed that this is due to the nature of the Ln³⁺ excited state, which is largely isolated from the influence of nearby atoms, and the presence of the ligands, which effectively separate the Ln³⁺ ions. [8; 9; 10; Quici, S.; Marzanni, G.; Cavazzini, M.; Anelli, P. L.; Botta, M.; Gianolio, E.; Accorsi, G.; Armaroli, N.; Barigelletti, F. Inorg. Chem. 2002, 41, 2777-2784.; Huhtinen, P.; Kivela, M.; Kuronen, O.; Hagren, V.; Takalo, H.; Tenhu, H.; Lovgren, T.; Harma, H. Anal. Chem. 2005, 77, 2643-2648.; Hemmila, I.; Laitala, V. J. Fluoresc. 2005, 15, 529-542.] A luminescence quantum yield of 6% was measured lot the Eu(DBM)₃TPPO/OTS nanoparticles using a dilute solution of Coumarin 1 in ethanol as a standard. The quantum yield of the encapsulated Eu(DBM)₃TPPO nanoparticles is approximately 30% higher than that of the chelate in THF solution. A similar increase in luminescence yield for silica host doped with Eu³⁺ chelates as compared to pure chelate has been reported previously [Zhao, D.; Qin, W. P.; Wu, C. F.; Qin, G. S.; Zhang, J. S.; Lu, S. Z. Chem. Phys. Lett. 2004, 388, 400-405.; Ji, X. L.: Li, B.; Jiang, S. C.; Dong, D. W.; Zhang, H. J.; Jing, X. B.; Jiang, B. Z. J. Non-Cyst. Solids 2000, 275, 52-58.] and is attributable to a reduction in the number of vibrational modes that couple to nonradiative transitions. The luminescence brightness is defined as the product molar absorption coefficient and the quantum yield. On the basis of the large absorptivity and quantum yield of these nanoparticles, the calculated luminescence brightness is many times larger than that of conventional fluorescent dyes and comparable to that of colloidal semiconductor quantum dots. [Hohng, S.; Ha, T. ChemPhysChem 2005, 6, 956-960.]

The luminescence decay curves of the Eu³⁺ chelate in THF solution and encapsulated nanoparticles are presented in FIG. 4b. The luminescence decay of the chelate in THF solution corresponds to a single-exponential function with a time constant of 172 μs. The luminescence decay of the nanoparticles does not fit to a single-exponential function, whereas a biexponential function yields a good fit with time constants of 70 μs (60% amplitude) and 243 μs (40% amplitude). Similar biexponential decay was observed in silica spheres containing a similar Eu³⁺ chelate and is attributable to site-to-site heterogeneity in the solid state. [Zhao, D.; Qin, W. P.; Zhang, J. S.; Wu, C. F.; Qin, G. S.; De, G. J. H.; Zhang, J. S.; Lu, S. Z. Chem. Phys. Lett. 2005. 403, 129-134.; Zhao, D.; Qin, W. P.; Wu, C. F.; Qin, G. S.; Zhang, J. S.; Lu, S. Z. Chem. Phys. Lett. 2004, 388, 400-405.] The decreased lifetime and increased quantum yield were also observed in Eu³⁺ chelate-loaded silica spheres as compared to pure late and were attributed to an increase in the radiative rate. [Zhao, D.; Qin, W. P.; Zhang, J. S.; Wu, C. F.; Qin, G. S.; De, G. J. H.; Zhang, J. S.; Lu, S. Z. Chem. Phys. Lett. 2005. 403, 129-134.; Zhao, D.; Qin, W. P.; Wu, C. F.; Qin, G. S.; Zhang, J. S.; Lu, S. Z. Chem. Phys. Lett. 2004, 388, 400-405.] Photostability is another key figure of merit for luminescent probes. The decay of the luminescence of both the Eu³⁺ chelate in THF solution and the encapsulated nanoparticles under continuous UV light illumination was determined (FIG. 4c). It was observed that the emission intensity of the Eu³⁺ chelate in THF solution decreased by approximately 80% over the course of 2 h whereas the emission intensity of the Eu³⁺ chelate/OTS nanoparticles showed only a slight decrease (about 10%) over the same period, corresponding to a decrease in the photobleaching rate by a factor of twenty. Without wishing to be bound by theory, it is believed that the high photostability of the encapsulated nanoparticles can be attributed to the isolation of the Eu³⁺ chelate from the outside environment by a layer of hydrolyzed OTS, which can shield the chelate from solvent molecules and free radicals caused by light exposure and effectively protecting the molecules from photodecomposition.

### D. Lanthanide-Based Nanoparticles

In one aspect, the invention relates to a lanthanide-based nanoparticle exhibiting a luminescence brightness of at least about 4%×(3×10⁷ M⁻¹ cm⁻¹) with a particle diameter of less than about 100 nm. In a further aspect, the invention relates to a stable, luminescent nanoparticle comprising a core comprising at least one lanthanide chelate and a shell comprising organic silane residues, wherein the nanoparticle exhibits a molar extinction coefficient of at least about 3×10⁷ M⁻¹ cm⁻¹ at its wavelength of maximum absorbance from about 300 nm to about 400 nm and/or wherein the nanoparticle exhibits a luminescence quantum yield of at least about 4%, and wherein the nanoparticle exhibits a luminescence brightness of at least about 4%×(3×10⁷ M⁻¹ cm⁻¹). In a further aspect, the lanthanide chelate comprises at least one lanthanide metal and at least one aromatic ligand capable of absorbing light within the range of from about 300 nm to about 500 nm.

1. Lanthanides

In one aspect, the lanthanide is Europium. In a further aspect, is Praseodymium, Neodymium, Samarium, Europium, Terbium, Dysprosium, Holmium, Erbium, or Ytterbium.

2. Nanoparticle Core Composition

In the disclosed compositions and methods, a large number of Ln³⁺ chelate molecules can contained in a small particle. Thus, in one aspect, the lanthanide chelate comprises at least about 75 wt % of the core, for example, at least about 80 wt % of the core, at least about 85 wt % of the core, at least about 90 wt % of the core, or at least about 95 wt % of the core. In a further aspect, the core consists essentially of the at least one lanthanide chelate.

In a yet further aspect, the nanoparticle comprises a core consisting essentially of Eu(DBM)₃TPPO and a shell comprising residues of octyl trimethoxysilane, wherein the nanoparticle exhibits a molar extinction coefficient of at least about 5×10⁷ M⁻¹ cm⁻¹ at 350 nm and wherein the nanoparticle exhibits a luminescence quantum yield of at least about 6%.

3. Particle Size

While the nanoparticle, in one aspect, can have a particle diameter (particle size) of less than about 100 nm, in further aspects, the nanoparticle can have a diameter of less than about 40 nm, less than about 30 nm, or less than about 15 nm.

In a further aspect, the average particle diameter can be from about 5 nm to about 60 nm, from about 5 nm to about 40 nm, from about 5 nm to about 30 nm, from about 5 nm to about 20 nm, from about 5 nm to about 15 nm, or about 10 nm. That is, in one aspect, at least about 50% of the nanoparticles have a diameter of from about 5 nm to about 60 nm, from about 5 nm to about 40 nm, from about 5 nm to about 30 nm, from about 5 nm to about 20 nm, from about 5 nm to about 15 nm, or about 10 nm.

4. Molar Extinction Coefficient

In certain aspects, the nanoparticle can have a molar extinction coefficient at its wavelength of maximum absorbance from about 300 nm to about 400 nm. For example, molar extinction coefficient can be at least about 5×10⁵ M⁻¹ cm⁻¹, at least about 5×10⁵ M⁻¹ cm⁻¹, at least about 1×10⁶ M⁻¹ cm⁻¹, at least about 5×10⁶ M⁻¹ cm⁻¹, at least about 1×10⁷ M⁻¹ cm⁻¹, at least about 3×10⁷ M⁻¹ cm⁻¹, or at least about 5×10⁷ M⁻¹ cm⁻¹.

5. Luminescence Quantum Yield

In certain aspects, the nanoparticle can have a luminescence quantum yield. For example, the luminescence quantum yield can be at least about 2%, at least about 3%, at least about 4%, at least about 5%, or at least about 6%.

6. Luminescence Brightness

Thus, as the luminescence brightness is defined as the product molar absorption coefficient and the quantum yield, the nanoparticle can have a luminescence brightness. For example, the nanoparticle can exhibit a luminescence brightness of at least about 4%×(1×10⁷ M⁻¹ cm⁻¹), at least about 4%×(3×10⁷ M⁻¹cm⁻¹), at least about 4%×(5×10⁷ M⁻¹ cm⁻¹), at least about 5%×(1×10⁷ M⁻¹ cm⁻¹), at least about 5%×(3×10⁷ M⁻¹ cm⁻¹), at least about 5%×(5×10⁷ M⁻¹ cm⁻¹), at least about 6%×(1×10⁷ M⁻¹ cm⁻¹), at least about 4%×(3×10⁷ M⁻¹ cm⁻¹), or at least about 6%×(5×10⁷ M⁻¹ cm⁻¹).

7. Ligands

The ligands employed to provide the lanthanide chelates can be selected to take advantage of the “antenna effect,” whereby organic chromophores coordinated with lanthanide ions serve as antennas to absorb light and then transfer energy to the metal ions, thereby effectively increasing the extinction coefficients of the resultant nanoparticle.

Suitable ligands include beta-diketone derivatives such as dibenzoylmethanato (DBM), thenoyltrifluoroacetonate (TTA), benzoyltrifluoroacetone (BTA), naphthyltrifluoroacetone (NTA), and benzoylacetone (BA). Further suitable ligands include derivatives of pyridine, bipyridine, terpyridine, salicylate, coumarin derivatives, phenanthroline, and pyrazole. Those of skill in the art can select additional suitable ligands, which are disclosed in, for example, Hemmila et al., “Time-Resolution in Fluorometry Technologies, Labels, and Applications in Bioanalytical Assays,” CRITICAL REVIEWS IN CLINICAL LABORATORY SCIENCES, 38(6):441-519 (2001); Parker et al., “Being Excited by Lanthanide Coordination Comlexes: Aqua Species, Chirality, Excited-State Chemistry, and Exchange Dynamics,” CHEM. REV., 2002, 102, 1977-2010; and de Sa et al., “Spectroscopic properties and design of highly luminescent lanthanide coordination complexes,” COORDINATION CHEMISTRY REVIEWS, 196 (2000), 165-195.

8. Stability

The disclosed nanoparticles exhibit enhances resistance to photobleaching, when compared to conventional lanthanide nanoparticles of comparable size. For example, a disclosed nanoparticle can absorb greater than about 1×10⁶, greater than about 2×10⁶, greater than about 5×10⁶, greater than about 1×10⁷, or about 2×10⁷ photons before its luminescence brightness is reduced by about 50%.

Although no appropriate photostability measurements on conventional doped silica particles have been reported, estimations of their stability can be based upon the number of chelate molecule per particle. This indicates that a conventional lanthanide chelate-doped polymer or silica particle of a size similar, having a factor of twenty-fold lower chelate density, would absorb about twenty-fold fewer photons prior to photobleaching. Thus, on a per nanoparticle basis, each conventional nanoparticle can absorb only about 1×10⁶ photons (e.g., ultraviolet photons) before its luminescence intensity is reduced by 50%.

It is understood that, in one aspect, the disclosed nanoparticles can be produced by the disclosed methods.

### E. Methods for Making Nanoparticles

In one aspect, the invention relates to a process for preparing a stable, luminescent nanoparticle, the process comprising the step of combining a basic protic solvent with a mixture of an alkylsilane and an aprotic solution of lanthanide chelate. For example, the method can comprise the steps of providing a solution of at least one lanthanide chelate in an aprotic solvent; mixing an alkyl silane with the solution in a molar ratio of from about 1:1 to about 10:1 (alkyl alkoxysilane:lanthanide chelate); injecting the mixture into a protic solvent having a pH of greater than about 7, thereby producing a suspension of encapsulated nanoparticles.

In a further aspect, the process can further comprise the steps of filtering the suspension; removing by evaporation at least a portion of the aprotic solvent; and re-filtering the suspension. While the second filtration step is not strictly necessary, this step can be useful as a diagnostic to determine if aggregation had occurred.

In a further aspect, the solution can comprise Eu(DBM)₃TPPO in tetrahydrofuran at a concentration of about 0.05 wt %; the alkyl alkoxysilane can comprise octyl trimethoxysilane; the molar ratio can be about 5:1 (octyl trimethoxysilane:Eu(DBM)₃TPPO); the protic solvent can comprise water having a pH of about 9, and the method further comprises the steps of: filtering the suspension with a 0.2 μm membrane; removing by evaporation at least a portion of the tetrahydrofuran; and re-filtering the suspension with a 0.2 μm membrane.

1. Solutions

In one aspect, a lanthanide chelate can be dissolved in an aprotic solvent, that is, a solvent that does not exchange protons with a substance dissolved in it. Suitable aprotic solvents include tetrahydrofuran, dialkyl ethers (e.g., diethyl ether), ketones (e.g., acetone and methyl isobutyl ketone), esters (e.g., ethyl acetate), amides (e.g., dimethylformamide), and mixtures thereof.

In one aspect, the protic solvent can be water, one or more alcohols, or a mixture thereof In certain aspects, the pH of the solvent can be adjusted to greater than about 7, for example, greater than about 7.5, greater than about 8, greater than about 8.5, greater than about 9, or greater than about 9.5.

In various aspects, the lanthanide chelate solution is provided with a concentration of from about 0.001 wt % to about 10 wt %, for example, from about 0.005 wt % to about 5 wt %, from about 0.005 wt % to about 1 wt %, from about 0.01 wt % to about 5 wt %, or from about 0.01 wt % to about 1 wt %.

2. Encapsulating Agent

The disclosed methods can be used in connection with an encapsulating agent (e.g., an electrophilic alkylsilane such as octyltrimethoxysilane (OTS)). Suitable encapsulating agents include electrophilic alkylsilanes bearing one or more leaving groups. The alkyl moiety can be selected from, for example, C2 to C40 alkyl, C2 to C36 alkyl, C2 to C24 alkyl, C4 to C24 alkyl, C6 to C24 alkyl, and C6 to C12 alkyl, including hexyl, heptyl, octyl, nonyl, decyl, undecyl, and dodecyl. The alkyl moiety can be linear, branched, acyclic, or cyclic. The alkyl moiety can be further substituted with one or more organic functionalities. The leaving groups can be, for example, one, two, or three halides or alkoxyl groups, or a mixture thereof.

Suitable encapsulating agents include hexyltrialkoxysilanes, octyltrialkoxysilanes, decyltrialkoxysilanes, docecyltrialkoxysilanes, hexyltrihalosilanes, octyltrihalosilanes, decyltrihalosilanes, and docecyltrihalosilanes.

In various aspects, the molar ratio of encapsulating agent to lanthanide chelate is from about 1:1 to about 20:1, from about 1.5:1 to about 15:1, from about 2:1 to about 10:1, from about 2:1 to about 7:1, from about 3:1 to about 10:1, or from about 3:1 to about 7:1.

It is understood that, in one aspect, the disclosed methods can be used to provide the disclosed nanoparticles.

### F. Experimental

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C or is at ambient temperature, and pressure is at or near atmospheric.

The Eu³⁺ chelate, Eu-tris(dibenzoylmethane)-mono(triphenylphosphineoxide) (Eu(DBM)₃TPPO) was prepared as described elsewhere. [Wang, M.; Jin, L.; Liu, S.; Cai, G.; Huang, J.; Qin, W.; Huang, S. Sci. China, Ser. B 1994, 23, 1028-1034.] Nanoparticle suspensions of the chelate were prepared by a reprecipitation-encapsulation method that is described as follows: Solid Eu(DBM)₃TPPO was dissolved in tetrahydrofuran (THF, 99.9%, Aldrich) to a concentration of 0.05 wt %. Encapsulating agent octyl trimethoxysilane (OTS) was added to the chelate solution at the OTS to a Eu(DBM)₃TPPO molecular ratio of 1:5. The chelate/OTS solution (200 μL) was injected quickly into 8 mL of distilled water while the mixture was under sonication. Prior to injection, the pH value of the distilled water was adjusted to about 9 by adding ammonium hydroxide (28%, Aldrich). The as-prepared samples were filtered through a 0.2 um membrane filter (Millipore). The THF was removed by partial vacuum evaporation, followed by another filtration through a 0.2 um filter. Multiple experiments indicate that the preparation method reproducibly produced nanoparticles, with a typical nanoparticle yield of 80-90%. For comparison, additional samples were prepared without the OTS agent, with different OTS concentrations, and with OTS but without ammonium hydroxide.

The morphology and size distribution of the Eu³⁺ chelate nanoparticles were characterized by atomic force microscopy (AFM). One drop of the nanoparticle dispersion was placed on a freshly cleaned oxidized silicon substrate. After the evaporation of water, the surface was scanned with a Digital Instruments multimode AFM in tapping mode. The UV-vis absorption spectra were recorded with a Shimadzu UV-2101PC scanning spectrophotometer using a 1 cm quartz cuvette. Steady-state luminescence spectra were collected from the nanoparticle dispersion in a 1 cm quartz cuvette using a commercial fluorometer (Quantamaster, PTI, Inc.). For luminescence quantum yield measurements, a dilute solution of coumarin 1 in ethanol was used as a standard. Both the nanoparticle dispersion and the coumarin 1/ethanol solution were adjusted to have an absorbance of 0.10. The emission spectra were recorded by using the PTI fluorometer. A corrected luminescence integrated area was used to calculate the quantum yield. The photobleaching experiments were done on the same fluorometer that was set to generate continuous UV light (360 nm) at a power of 1.0 mW. The light was focused into a quartz cell containing a constantly stirred nanoparticle dispersion or Eu³⁺ chelate in THF solution with an absorbance of 0.10. The luminescence decrease at 613 nm wavelength was recorded in a time period of 2 h. The luminescence decay lifetime was measured using a home-built photon-counting spectrometer. The sample was excited by pulses from a light-emitting diode (370 nm) driven by a programmable function generator (Seintek G5100). Luminescence emission was collected in perpendicular geometry, separated through a 500 nm long-pass filter, and detected by a single photon-counting module (Perkin-Elmer, SPCM-AQR). A digital counter card (National Instruments model 6602) was configured to record photon arrival events at better than 1 μs resolution.

The photostability curves were obtained with the following experimental conditions: Absorbance: 0.1; Excitation wavelength: 360 nm; Excitation power: 1 mW; Duration: 2 hours.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A lanthanide-based nanoparticle exhibiting a luminescence brightness of at least about 4%×(3×10⁷ M⁻¹ cm⁻¹) with a particle diameter of less than about 100 nm.

2. The nanoparticle of claim 1, wherein the lanthanide is Europium.

3. The nanoparticle of claim 1, wherein the lanthanide is Praseodymium, Neodymium, Samarium, Europium, Terbium, Dysprosium, Holmium, Erbium, or Ytterbium.

4. The nanoparticle of claim 1, wherein the nanoparticle has a diameter of less than about 40 nm.

5. The nanoparticle of claim 1, wherein the nanoparticle exhibits a luminescence brightness of at least about 6%×(5×10⁷ M⁻¹ cm⁻¹).

6. A stable, luminescent nanoparticle comprising:
a. a core comprising at least one lanthanide chelate and
b. a shell comprising organic silane residues,
wherein the nanoparticle exhibits a molar extinction coefficient of at least about 3×10⁷ M⁻¹ cm⁻¹ at its wavelength of maximum absorbance from about 300 nm to about 400 nm and/or
wherein the nanoparticle exhibits a luminescence quantum yield of at least about 4%, and
wherein the nanoparticle exhibits a luminescence brightness of at least about 4%×(3×10⁷ M⁻¹ cm⁻¹).

7. The nanoparticle of claim 6, wherein the lanthanide chelate comprises at least one lanthanide metal and at least one aromatic ligand capable of absorbing light within the range of from about 300 nm to about 500 nm.

8. The nanoparticle of claim 7, wherein the aromatic ligand comprises a beta-diketone derivative selected from dibenzoylmethanato, thenoyltrifluoroacetonate, benzoyltrifluoroacetone, naphthyltrifluoroacetone, and benzoylacetone; or a derivative of pyridine, bipyridine, terpyridine, salicylate, coumarin derivatives, phenanthroline, or pyrazole.

9. The nanoparticle of claim 6, wherein the lanthanide metal is selected from Praseodymium, Neodymium, Samarium, Europium, Terbium, Dysprosium, Holmium, Erbium, and Ytterbium.

10. The nanoparticle of claim 6, wherein the nanoparticle can absorb greater than about 1×10⁶ before its luminescence brightness is reduced by about 50%.

11. The nanoparticle of claim 6, wherein lanthanide chelate comprises at least about 75 wt % of the core.

12. The nanoparticle of claim 6, wherein lanthanide chelate comprises at least about 90 wt % of the core.

13. The nanoparticle of claim 6, wherein lanthanide chelate comprises at least about 95 wt % of the core.

14. The nanoparticle of claim 6, wherein the core consists essentially of the at least one lanthanide chelate.

15. The nanoparticle of claim 6, comprising:
a. a core consisting essentially of Eu(DBM)₃TPPO and
b. a shell comprising residues of octyl trimethoxysilane,
wherein the nanoparticle exhibits a molar extinction coefficient of at least about 5×10⁷ M⁻¹ cm⁻¹ at 350 nm and
wherein the nanoparticle exhibits a luminescence quantum yield of at least about 6%.

16. The nanoparticle of claim 6, wherein the nanoparticle exhibits a luminescence brightness of at least about 6%×(5×10⁷ M⁻¹ cm⁻¹).

17. A plurality of nanoparticles of claim 15, wherein at least about 50% of the nanoparticles have a diameter of from about 5 nm to about 15 nm.

18. A process for preparing a stable, luminescent nanoparticle, the process comprising the step of combining a basic protic solvent with a mixture of an alkylsilane and an aprotic solution of lanthanide chelate.

19. The process of claim 18, comprising the steps of:
a. providing a solution of at least one lanthanide chelate in an aprotic solvent;
b. mixing an alkyl silane with the solution in a molar ratio of from about 1:1 to about 10:1 (alkyl silane:lanthanide chelate);
c. injecting the mixture into a protic solvent having a pH of greater than about 7, thereby producing a suspension of encapsulated nanoparticles.

20. The process of claim 19, further comprising the steps of:
a. filtering the suspension;
b. removing by evaporation at least a portion of the aprotic solvent; and
c. re-filtering the suspension.

21. The process of claim 19, wherein the lanthanide chelate solution has a concentration of from about 0.01 wt % to about 1 wt %.

22. The process of claim 19, wherein the molar ratio is from about 3:1 to about 7:1 (alkyl silane:lanthanide chelate)

23. The process of claim 19, wherein protic solvent has a pH of greater than about 8.

24. The process of claim 19, wherein the solution comprises Eu(DBM)₃TPPO in tetrahydrofuran at a concentration of about 0.05 wt %;
wherein the alkyl alkoxysilane comprises octyl trimethoxysilane;
wherein the molar ratio is about 5:1 (octyl trimethoxysilane:Eu(DBM)₃TPPO);
wherein the protic solvent comprises water having a pH of about 9, and further comprising the steps of:
a. filtering the suspension with a 0.2 μm membrane;
b. removing by evaporation at least a portion of the tetrahydrofuran; and
c. re-filtering the suspension with a 0.2 μm membrane.

25. The product of the process of claim 18.
